(19) United States
(12) Patent Application Publication
(10) Pub. No.: US 2026/0182730 A1
(43) Pub. Date: Jul. 2, 2026

(54) MULTI-HEADED TOOTH BRUSH FOR BRUSHING AND FLOSSING

(71) Applicant: ZAINAB ADEYEMO, Des Plaines, IL (US)

(72) Inventor: ZAINAB ADEYEMO, Des Plaines, IL (US)

(73) Assignee: EVIDENT SOLUTIONS, INC., SHERIDAN, WY (US)

(21) Appl. No.: 19/004,308

(22) Filed: Dec. 28, 2024

(51) Int. Cl. A46B 9/04; A46B 11/00; A46B 15/00

(52) U.S. Cl. CPC A46B 9/045; A46B 11/002; A46B 15/0071; A46B 2200/1066

(57) ABSTRACT

The invention provides a double-sided or triple-sided toothbrush head is designed to reach every angle, making brushing and flossing faster, easier, and more effective. More specifically, the toothbrush head herein combines brushing and water flossing into a compact toothbrush brush head device that combines both tooth brushing and flossing to simplify the brushing routine.

### FIELD OF THE INVENTION

The invention provides a double-sided or triple-sided toothbrush head is designed to reach every angle, making brushing and flossing faster, easier, and more effective. More specifically, the toothbrush head herein combines brushing and water flossing into a compact toothbrush brush head device that combines both tooth brushing and flossing to simplify the brushing routine.

### BACKGROUND OF THE INVENTION

The development of toothbrushes has a long history dating back thousands of years, evolving significantly to meet advancing oral hygiene needs. The earliest known toothbrush-like tools date to ancient civilizations, where chewing sticks made from aromatic trees were used to clean teeth and freshen breath. The first modern toothbrush, however, is credited to China around the Tang Dynasty (619-907 AD), when animal hair was attached to bamboo or bone handles, providing a more effective cleaning tool.

Modern toothbrush patents encompass innovations in bristle design, handle ergonomics, and brush head configurations, as well as mechanical and electric enhancements. Various patents also focus on improving brushing efficiency, targeting multiple surfaces of teeth, incorporating flexible heads, and adding components for additional functions such as tongue cleaning. The advent of sonic and ultrasonic technology further revolutionized toothbrushes, allowing for deeper cleaning through high-frequency vibrations.

Recent toothbrush patents have increasingly incorporated multifunctional features, combining brushing and flossing, water flossing, and even antibacterial elements. These innovations reflect growing consumer demand for comprehensive oral care tools that improve efficacy, convenience, and user experience. In this context, each new patented design, whether manual or electric, aims to address unique challenges, such as accessing hard-to-reach areas, reducing plaque more effectively, and promoting better oral health habits.

### SUMMARY OF THE INVENTION

Accordingly, the invention provides a toothbrush design introduces a unique structure aimed at enhancing oral hygiene by combining brushing and flossing in one tool. The toothbrush features a grasping portion that is easy for a user to hold and an extended portion that attaches securely to the grasping section, forming a sturdy base for the brush head.

The brush portion itself is designed with two angled heads, each equipped with bristles on one side. These heads face one another, creating a gap between them that allows the bristles to encircle one or more teeth, enabling effective cleaning on multiple sides at once. Some versions of the toothbrush also integrate a flossing component nestled within the bristles of one or both heads, adding the benefit of water flossing. This setup allows for simultaneous brushing and flossing as the bristles and flossing components work in unison to clean teeth more thoroughly.

In another configuration, the toothbrush includes three bristled surfaces: two on the outer sides and one positioned between them, providing an even more comprehensive cleaning as each surface can reach a different side of a tooth. In this variation, the middle bristled surface may also include a flossing component, further enhancing the toothbrush's ability to deliver a thorough, multi-dimensional clean.

Overall, this innovative toothbrush design offers an improved brushing experience by maximizing tooth surface coverage and enabling a combination of brushing and flossing actions, all in a single, easy-to-use tool.

### BRIEF DESCRIPTION OF THE FIGURES

The various exemplary embodiments of the present invention, which will become more apparent as the description proceeds, are described in the following detailed description in conjunction with the accompanying drawings, in which:

FIG. 1A is a two dimensional drawing of the entire toothbrush embodiment herein;

FIG. 1B is an exploded view of the toothbrush embodiment of FIG. 1A that shows the separation of three parts of the toothbrush;

FIG. 2 is a perspective view of the brush head of the toothbrush embodiment herein;

FIG. 3 is an exploded three-dimensional exploded view of the brush head showing the bristle portion removed from the brush head body; and

FIG. 4 is a perspective view of the inventive embodiment being used within a user's mouth.

### DETAILED DESCRIPTION OF THE INVENTION

The following description is provided as an enabling teaching of the present systems, and/or methods in its best, currently known aspect. To this end, those skilled in the relevant art will recognize and appreciate that many changes can be made to the various aspects of the present systems, and/or methods described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a”, “an” and “the” include plural referents unless the context clearly dictates otherwise. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can”, “could”, “might”, or “may”, unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods.

Thus, if there are a variety of additional steps that can be performed it is understood that each of these additional steps can be performed with any specific aspect or combination of aspects of the disclosed methods.

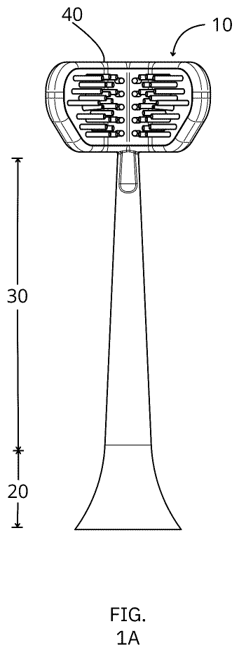

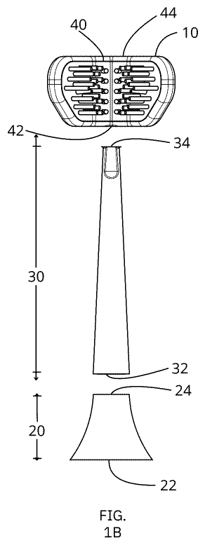

FIG. 1A is a two dimensional drawing of the entire toothbrush embodiment herein. As shown, toothbrush 10 comprises three main parts, grasping portion 20, stem 30, and brush head 40. Grasping portion 20 serves as the base of toothbrush 10 in which it sit up erectly and securely upon the bottom of grasping portion 20. Extending from the top of grasping portion 20 is stem 30 which extends a suitable length from grasping portion 20. Brush head 40 sits atop stem 30.

Brush head 40 is connected to stem 30 and can be removed. At some point, brush head 40 may wear out and need to be replaced. When necessary, brush head 40 can be clicked off of toothbrush 10 (i.e., detached from stem 30). In its attached state, brush head 40 is fully engaged with toothbrush 10 via its attachment to stem 30.

FIG. 1B provides an exploded view of the toothbrush embodiment of FIG. 1A that shows the separation of three parts of toothbrush 10. Grasping portion 20 comprises first end 22 and second end 24 positioned oppositely to first end 22. Stem 30 likewise comprises first end 32 and second end 34 positioned oppositely to first end 32. In practice, second end 24 of grasping portion 20 connects to first end 32 of stem 30. Brush head 40 comprises a first end 42 and a second end 44 positioned oppositely thereto. First end 42 of brush head 40 sits upon and is connected to second end 34 of stem 30.

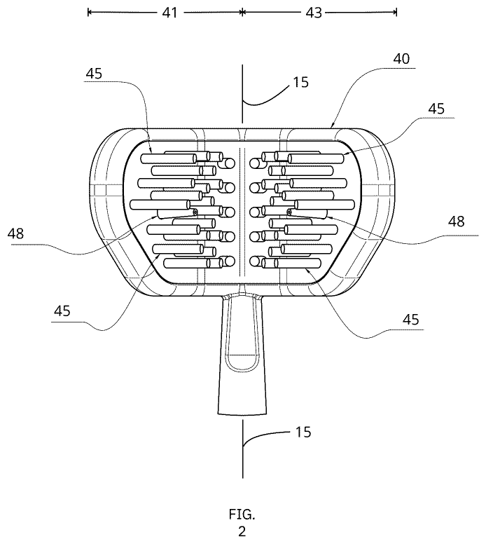

FIG. 2 is a perspective view of brush head 40 of toothbrush 10 embodiment herein. A multiplicity of bristles 45 are shown positioned onto the surface of brush head 40. Also included are a pair, at least, of flossing portals 48 (or “nozzles” or “nozzle members”). Persons of skill in the art will recognize that bristles 45 are the same or similar to bristles currently in use for modern toothbrushes. The objective of bristles 45 is that they be as or more effective than current best in class toothbrush bristles currently in use by known toothbrush makers like ORAL-B® and SONIC®.

As is shown in FIG. 2, brush head 40 is bifurcated into at least a left side 42 and a right side 44. Both sides, whether left side 42 or right side 44, comprise bristles 45 and at least one flossing portal 48 on each side, left 42 and right 44. Each side of brush head 40 is preferably curved inwardly toward the longitudinal axis of toothbrush 10.

In another preferred embodiment herein, left side and right side of brush head 40 are movable about longitudinal axis 15 of toothbrush 10 such that bristles 45 can be moved closer and more tightly to a user's teeth. In another embodiment herein, each side, left 42 or right 44, can be individually actuated to rotate about longitudinal axis 15 of toothbrush 10.

Toothbrush 10 provides an electric powered water flossing for two sides of a subject tooth. Toothbrushes that offer water flossing functionality work by integrating a small water jet or stream into the brush head to help clean between teeth and along the gumline. The water flossing system of toothbrush 10 herein provides a water supply and pump system, flossing nozzle 48, adjustable pressures and modes in the water flossing system, and an electric power source.

The water supply and pump system provides a built-in reservoir within grasping portion 20 (i.e., the handle) or connected via tubing to a larger external reservoir that holds water, mouthwash or other suitable fluid. As part of the pumping system within the water flossing system, a small electric pump in the device pushes water from its fluid reservoir through tiny channels leading to the brush head.

Brush head 40 features one or more flossing nozzles 48 designed to emit a thin, pressurized stream of water, i.e., a “water jet”. As the toothbrush vibrates or moves, this water jet is directed between teeth and around the gums to dislodge food particles, plaque, and bacteria that standard brushing alone may not reach.

In the case of brush head 40 herein, dual water jets are provided that each flow from a pair of flossing nozzles 48 as is shown in FIG. 2. The water jets are formed from pressurized emanating from one or more reservoirs inside of toothbrush 10. When toothbrush 10 is in use, the water flossing stream coming from flossing nozzles 48 works in tandem with the brushing motion of toothbrush 10. Ideally, embodiments herein pulse and/or coordinate the water flow with its inherent electro-mechanical brushing action thereby enhancing both the cleaning and flossing effects of toothbrush 10. In many cases, this is achieved by alternating bristle movement and water pulses, allowing users to clean multiple surfaces of each tooth.

Preferably, embodiments herein provide adjustable pressure settings, allowing users to choose between a gentle flow for sensitive gums or a stronger flow for a deeper clean and flossing. Alternatively, some embodiments herein may also provide a gum massage function for gum stimulation or deep clean for a more intense flossing action.

Toothbrushes 10 herein are preferably battery-powered with, most preferably, rechargeable batteries of the type and kind well known and used by persons of skill in the art, enabling them to generate the necessary pressure and pulsations to drive the water flossing feature. Electric models are often capable of higher pressure levels, providing a more effective water flossing experience.

By combining the actions of brushing and water flossing, these toothbrushes aim to provide a more comprehensive oral hygiene routine. The pressurized water can reach areas that bristles alone might miss, particularly between tightly spaced teeth or under the gumline, which can help improve gum health, reduce plaque buildup, and achieve a more thorough clean than traditional brushing.

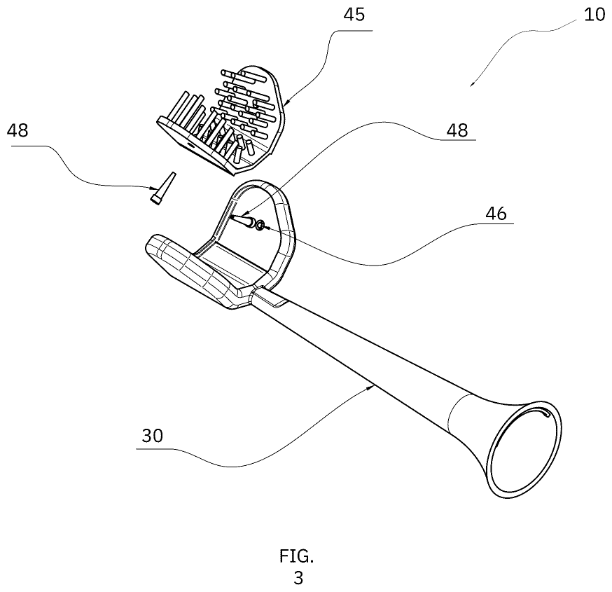

FIG. 3 is an exploded three-dimensional exploded view of the brush head showing the bristle portion removed from the brush head body. Particularly shown is the bristle portion, i.e., bristle head 45, removed from brush head 40. In practice, bristle head 45 is removable for replacement thereof when bristles 48 have become worn down. Also shown are nozzles 48 described hereinabove through which pressurized water jets flow to aid in cleaning of the teach and gums of a user's mouth.

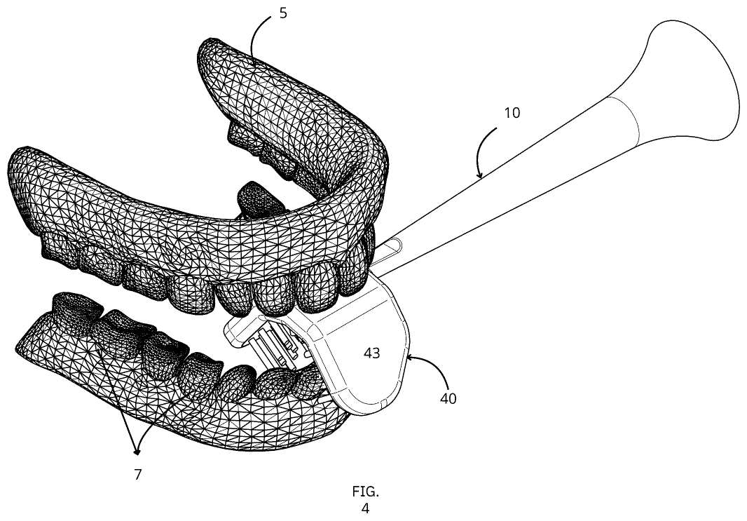

FIG. 4 is a perspective view of the inventive embodiment being used within a user's mouth. Brush head 40 will typically be oriented in a pre-curved position whereby right side 42 and left side 44 of brush head 40 curved to meet back and front surfaces of a user's teeth as is shown. Also, as noted hereinabove, brush head 40 may preferably be configured to curve further or away from a user's teeth to enable optimal cleaning through optimal surface contact. In another embodiment herein, each side, left 42 and right 44, can be separately, independently movable about longitudinal axis 15 for appropriate fit of each side of a user's mouth (i.e., teeth and gums).

As toothbrush 10, via brush head 40, moves through a user's row of teeth, bristles 48 contact the front and back surfaces of a user's teeth, as shown in FIG. 4. Also, powerful jet streams of water flow from two or more flossing portals 46, which jet streams being intended to clear a user's teeth along the gum line of a user's mouth. The jet streams discharged from flossing portals 48 are also meant to clean the areas between teeth as a flossing mechanism. Persons of skill in the art of dental care and toothbrush design will be well acquainted with water flossing devices whether singly used or incorporated within a traditional, prior art toothbrush design.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A toothbrush, comprising:
a. A grasping portion holdable by a human hand, said grasping portion having a first end and second end juxtaposed to said first end;
b. An extended portion having a first end and second end juxtaposed to said first end, said extended portion being attached to said second end of said grasping portion at said first end of said extended portion; and
c. A brush portion having
i. A first head having a first side and a second side juxtaposed to said first side, bristles being attached to said first side,
ii. A second head having a first side and a second side juxtaposed to said first side, bristles being attached to said first side,
iii. Each said first head and said second head being angled to at least partially face one-another thereby creating a gap at said facing, whereby said gap between said bristles of said first head and said second head receives one or more teeth for brushing.

2. The toothbrush of claim 1 wherein said first head of said brush portion comprises a flossing component nestled within said bristles of said first head.

3. The toothbrush of claim 1 wherein said second head of said brush portion comprises a flossing component nestled within said bristles of said second head.

4. The toothbrush of claim 3 wherein said flossing components of said first head and said second head provides water flossing.

5. The toothbrush of claim 4 wherein said bristles and said flossing components operate together to provide a simultaneous brushing and flossing operation for teeth in a user's mouth.

6. The toothbrush of claim 1 wherein said brush portion comprises a first surface with bristles, a second surface with bristles juxtaposed to said first surface with bristles and third surface with bristles ensconced between said first surface and said second surface.

7. The toothbrush of claim of 6 wherein said third surface comprises a flossing component.

8. The toothbrush of claim 7 wherein said flossing component provides water flossing.

9. The toothbrush of claim 6 wherein said first surface, said second surface and said third surface each touch a separate surface exposed surface of a user's tooth.

10. The toothbrush of claim 9 wherein said toothbrush touches a user's tooth on three sides.

11. A toothbrush, comprising:
a. A grasping portion holdable by a human hand, said grasping portion having a first end and second end juxtaposed to said first end;
b. An extended portion having a first end and second end juxtaposed to said first end, said extended portion being attached to said second end of said grasping portion at said first end of said extended portion; and
c. A brush portion having
i. A first surface having a first side and a second side juxtaposed to said first side, and bristles being attached to said first side,
ii. A second surface having a first side and a second side juxtaposed to said first side, and bristles being attached to said first side,
iii. A third surface having a first side and a second side juxtaposed to said first side, and bristles being attached to said first side,
iv. Each said first head and said second head being angled to at least partially face one-another thereby creating a gap at said facing, whereby said gap between said bristles of said first head and said second head receives one or more teeth for brushing.

12. The toothbrush of claim 11 wherein said first head of said brush portion comprises a flossing component nestled within said bristles of said first head.

13. The toothbrush of claim 11 wherein said second head of said brush portion comprises a flossing component nestled within said bristles of said second head.

14. The toothbrush of claim 13 wherein said flossing components of said first head and said second head provides water flossing.

15. The toothbrush of claim 14 wherein said bristles and said flossing components operate together to provide a simultaneous brushing and flossing operation for teeth in a user's mouth.
